(19) United States
(12) Patent Application Publication
(10) Pub. No.: US 2012/0140474 A1
(43) Pub. Date: Jun. 7, 2012

(54) RECONFIGURABLE LUMINAIRE

(76) Inventors: Pavel JURIK, Prostredni Becva (CZ); Josef Valchar, Prostredni Becva (CZ)

(21) Appl. No.: 13/229,666

(22) Filed: Sep. 9, 2011

Related U.S. Application Data
(60) Provisional application No. 61/381,687, filed on Sep. 10, 2010.

(51) Int. Cl. F21V 21/14

(52) U.S. Cl. 362/249.09

(57) ABSTRACT

Disclosed is an LED light source luminaire with a plurality of modules that can be reconfigured in a fixed manner.

### RELATED APPLICATION

The present application claims priority on Provisional Application No. 61/381,687 filed on 10 Sep. 2010.

### TECHNICAL FIELD OF THE INVENTION

The present invention generally relates to a luminaire, specifically to a luminaire utilizing an array of LED light sources.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. Many products provide control multiple parameters such as the intensity, color, focus, beam size, beam shape and beam pattern. Additionally it is becoming common to utilize high power LEDs as the light source in such luminaires and, for color control, it is common to use an array of LEDs of different colors. For example a common configuration is to use a mix of Red, Green and Blue LEDs. This configuration allows the user to create the color they desire by mixing appropriate levels of the three colors. For example illuminating the Red and Green LEDs while leaving the Blue extinguished will result in an output that appears Yellow. Similarly Red and Blue will result in Magenta and Blue and Green will result in Cyan. By judicious control of the LED controls the user may achieve any color they desire within the color gamut set by the LED colors in the array. More than three colors may also be used and it is well known to add an Amber or White LED to the Red, Green and Blue to enhance the color mixing and improve the gamut of colors available. The products manufactured by Robe Lighting such as the REDWash 3·192 are typical of the art.

In a prior art luminaire the configuration and shape of the array of LEDs is typically fixed at the time of manufacture. Thus different luminaires are needed to provide a linear array where the LEDs are mounted in-line or a square array where the LEDs are mounted in a square or rectangular pattern. However there are circumstances during the development of an event using such luminaires where it would be advantageous if the user or designer could determine the configuration and shape of the array at the time of use.

This is a need for an LED luminaire where the configuration and shape of the LED array can be altered by the user to suit the needs of the particular event where the luminaires are being used.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates the rear view of an embodiment of the disclosed LED luminaire;

FIG. 2 illustrates a detailed view of the connections of an embodiment of the disclosed LED luminaire;

FIG. 3 illustrates a further configuration of the embodiment of the LED luminaire illustrated in FIG. 1;

FIG. 4 illustrates a further configuration of the embodiment of the LED luminaire illustrated in FIG. 1;

FIG. 5 illustrates a further configuration of the embodiment of the LED luminaire illustrated in FIG. 1;

FIG. 6 illustrates a further configuration of the embodiment of the LED luminaire illustrated in FIG. 1;

FIG. 7 illustrates a further configuration of the embodiment of the LED luminaire illustrated in FIG. 1; and

FIG. 8 illustrates a further configuration of the embodiment of the LED luminaire illustrated in FIG. 1; and

FIG. 9 illustrates a typical system configuration of multiple LED luminaires illustrated in FIG. 1.

### DETAILED DESCRIPTION OF THE DISCLOSURE

Preferred embodiments of the present disclosure are illustrated in the FIGUREs, like numerals being used to refer to like and corresponding parts of the various drawings.

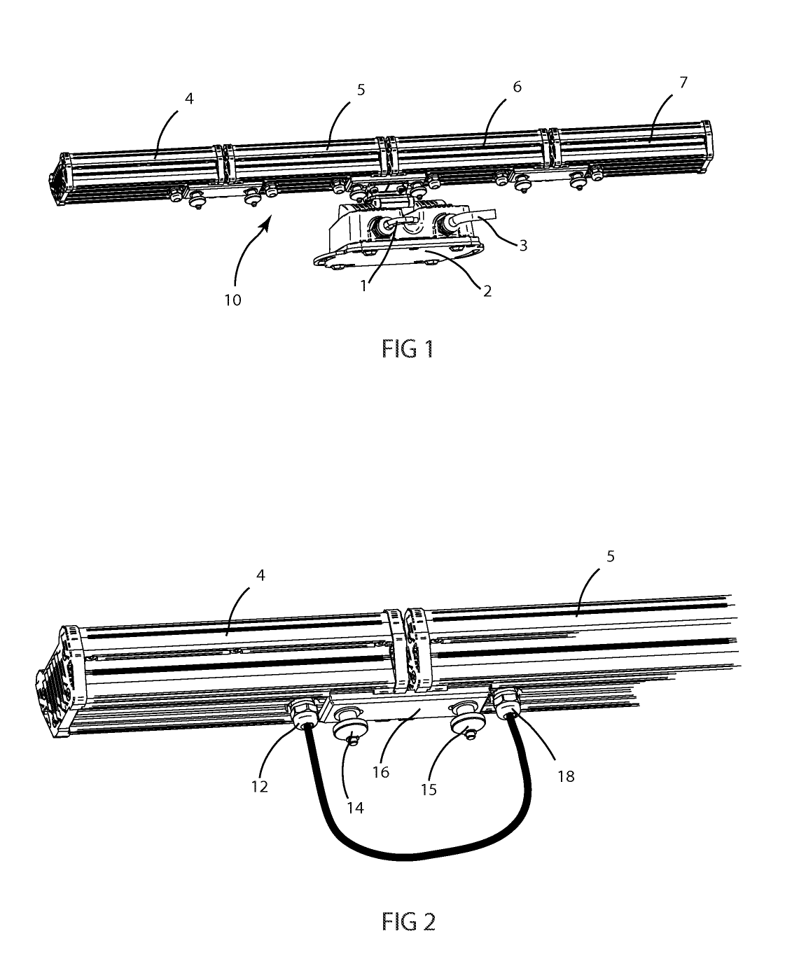

The present disclosure generally relates to a luminaire, specifically to a luminaire utilizing an array of LED light sources. FIG. 1 illustrates the rear view of an embodiment of the disclosed LED luminaire 10. LED modules 4, 5, 6 and 7 may each contain an array of LEDs. Such LED arrays may be of a single or multiple colors and may be configured for individual or combined control. In the configuration illustrated LED modules 4, 5, 6 and 7 are connected to form an in-line, linear arrangement. The complete assembly is mounted on LED support box 2 which receives power and data through links 1 and 3 and which may contain power supply and control components (not shown). Different embodiments of luminaire 10 may be electrically connected to other luminaires either in series or in parallel or in other configurations for power and/or data linkage.

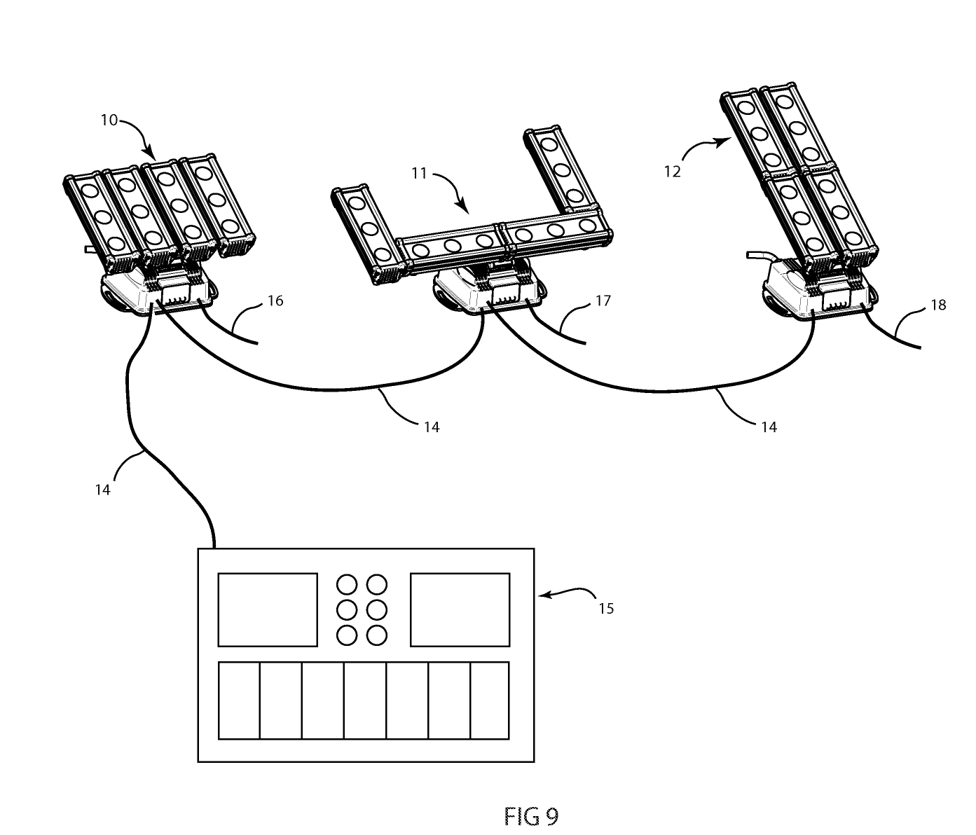

FIG. 9 illustrates a typical system utilizing multiple luminaires. These systems commonly include a plurality of luminaires 10, 11, 12. Each luminaire 10, 11, 12 may be configured in a different arrangement as shown or may be all configured to the same arrangement. In addition to being connected to mains power either directly or through a power distribution system (not shown) through power connections 16, 17, 18 each luminaire is connected is series or in parallel to data link 14 to one or more control desks 15. The luminaire system is typically controlled by an operator through the control desk 15.

FIG. 2 illustrates detail of the configurable connection system between LED modules. LED modules 4 and 5, for example, are connected by strap 16 and retaining bolts 14 and 15. Retaining bolts 14 and 15 may thread into sliding nut plates that run in a track in the rear of LED modules 4 and 5. When retaining bolts 14 and 15 are loosened each module may be rotated around the respective retaining bolt, and the rotation point may be slid along the track containing the nut plate. Each module may be adjusted to any desired angle and then retaining bolts 14 and 15 are re-tightened onto strap 16. An electrical cable provides connection for power and data from module to module between cable termination points 12 and 18. This arrangement of retaining bolts, sliding nut plates, connecting strap and connecting cable may be repeated as many times as desired to connect multiple LED modules together in a reconfigurable manner.

In the figures of this disclosure four (4) LED modules are illustrated, however the invention is not so limited and any number of LED modules may be connected in like manner. Modules may be interconnected in linear, star, radial or other connection patterns in order to facilitate the designer's wishes.

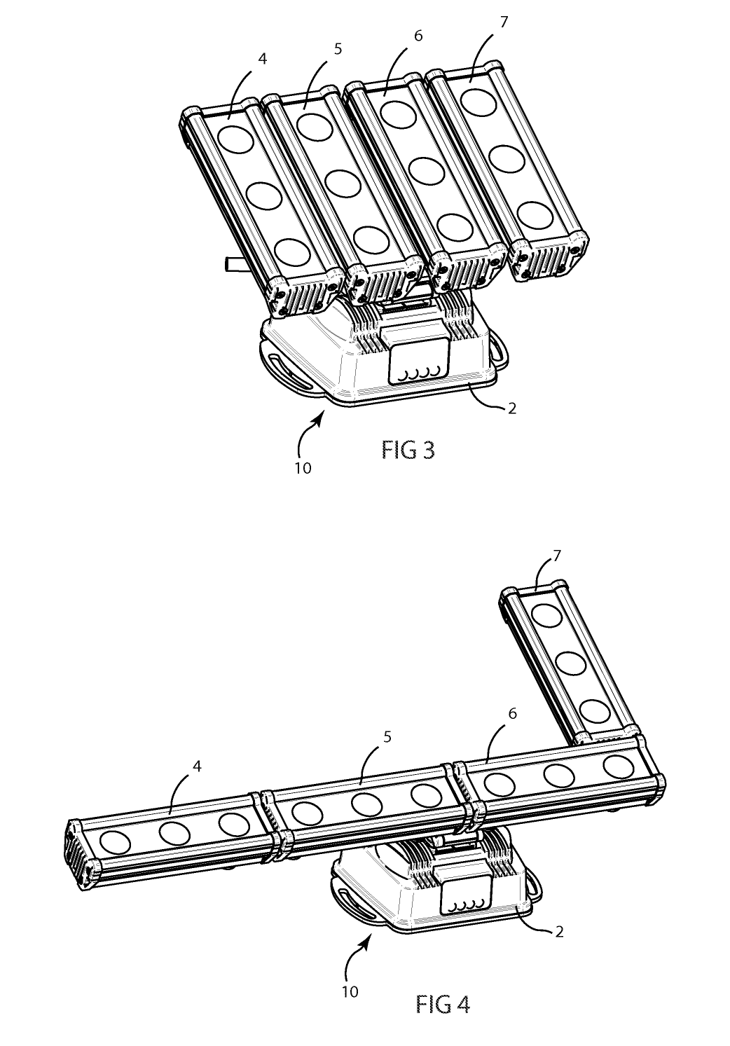

FIG. 3 illustrates the embodiment of the LED luminaire 10 where the retaining bolts, sliding nut plates, connecting strap and connecting cables have been adjusted and reconfigured so as to create a rectangular pattern of the LED modules.

FIG. 4 illustrates the embodiment of the LED luminaire 10 where the retaining bolts, sliding nut plates, connecting strap and connecting cables have been adjusted and reconfigured so as to create an ‘L’ shaped pattern of the LED modules.

FIG. 5 illustrates the embodiment of the LED luminaire 10 where the retaining bolts, sliding nut plates, connecting strap and connecting cables have been adjusted and reconfigured so as to create a ‘U’ shaped pattern of the LED modules.

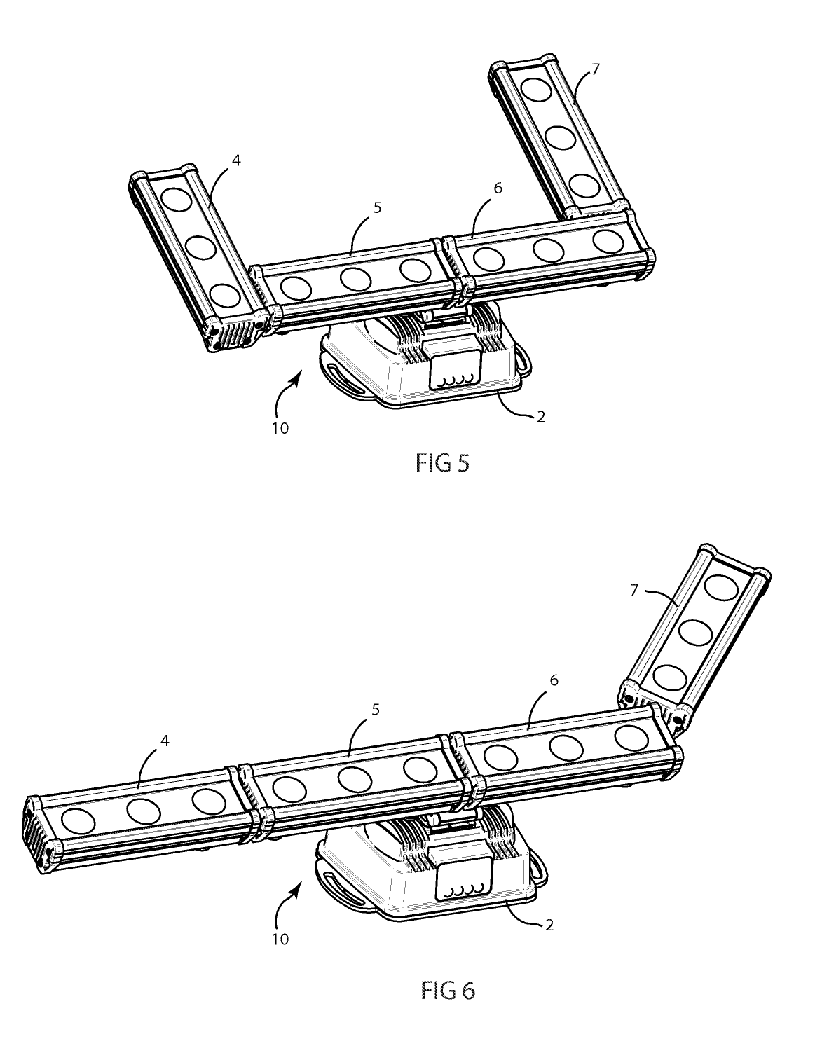

FIG. 6 illustrates the embodiment of the disclosed LED luminaire 10 where the retaining bolts, sliding nut plates, connecting strap and connecting cables have been adjusted and reconfigured so as to create an angled pattern of the LED modules. This embodiment demonstrates that adjustment of the LED modules is not restricted to 90° angles. In this embodiment the LED modules have been configured to provide a 135° angle between modules.

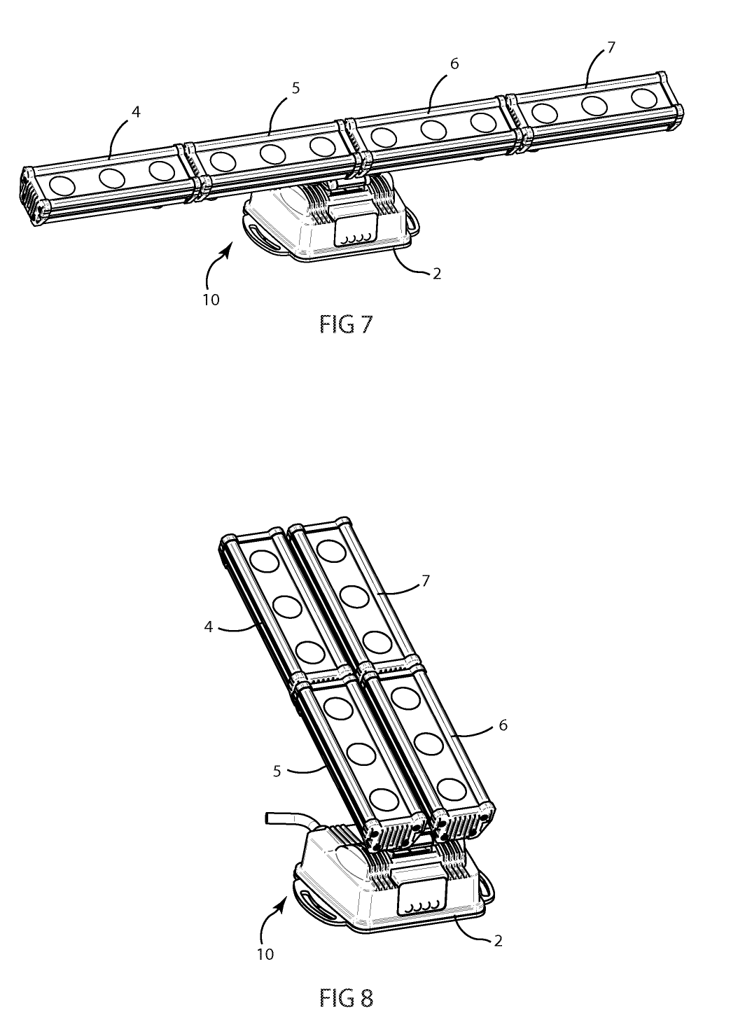

FIG. 7 illustrates the embodiment of the LED luminaire 10 where the retaining bolts, sliding nut plates, connecting strap and connecting cables have been adjusted and reconfigured so as to create a linear pattern of the LED modules.

FIG. 8 illustrates the embodiment of the disclosed LED luminaire 10 where the retaining bolts, sliding nut plates, connecting strap and connecting cables have been adjusted and reconfigured so as to create an extended rectangular pattern of the LED modules.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A luminaire with a plurality of fixable modules which can be configured and fixed in one configuration and reconfigured and fixed in a variety of different configurations.
